(19) United States
(12) Patent Application Publication
(10) Pub. No.: US 2010/0086603 A1
(43) Pub. Date: Apr. 8, 2010

(54) COMPOSITION FOR PHOTOPROTECTION

(75) Inventors: Ian Malcolm Shirley, Bracknell (GB); Alexander Mark Heming, Bracknell (GB); Stefan Franciscus Bon, Coventry (GB); Severine Michele Pascale Cauvin, Seneffe (BE)

Correspondence Address: SYNGENTA CROP PROTECTION , INC.;PATENT AND TRADEMARK DEPARTMENT, 410 SWING ROAD, GREENSBORO, NC, 27409, US

(73) Assignee: Syngenta Crop Protection, Inc., Greensboro, NC (US)

(21) Appl. No.: 12/440,888

(22) PCT Filed: Sep. 7, 2007
(86) PCT No.: PCT/GB07/03374

§ 371 Date: Nov. 13, 2009

(30) Foreign Application Priority Data
Sep. 11, 2006 (GB) 0617859.4

(51) Int. Cl. A01N 61/00; A01N 37/00; A01P 21/00

(52) U.S. Cl. 424/489; 514/529

(57) ABSTRACT

The present invention relates to a method for improving the lifetime of compounds that are prone to photo-degradation by containing the compounds in microcapsules, which have light protecting particles bonded chemically to the capsule walls. In particular, the present invention relates to a microcapsule comprising a biologically active compound inside the microcapsule and light protecting particles which are chemically bonded to the microcapsule wall material; to the use of such a microcapsule; to a process for preparing such a microcapsule; and to surface-modified light protecting particles and their use in such a microcapsule.

The present invention relates to a method for improving the lifetime of compounds that are prone to photo-degradation by containing the compounds in microcapsules, which have light protecting particles bonded chemically to the capsule walls. In particular, the present invention relates to a microcapsule comprising a biologically active compound inside the microcapsule and light protecting particles which are chemically bonded to the microcapsule wall material; to the use of such a microcapsule; to a process for preparing such a microcapsule; and to surface-modified light protecting particles and their use in such a microcapsule.

Many biologically active agrochemical compounds, commonly termed active ingredients (AIs), are photo-labile and may be degraded within hours or days upon exposure to sunlight, typically between the wavelengths of 200 nm to 800 nm. Degradation due to sunlight is typically termed photo-instability or photo degradation and an AI which is susceptible to such degradation is deemed to be photolabile, photo-unstable, photosensitive or light sensitive.

Photoprotectants may be used to photostabilise intrinsically photosensitive AIs. The term photoprotectant means a compound, or combination of compounds, that reduces the rate or extent of photo-degradation of an AI.

Microencapsulation technology may provide an effective means for photoprotection whereby a photoprotectant shields, or is in very close proximity to, the AI.
Capsule technologies have been known for a number of years (see, for example, GB1513614, CA2133779, WO00/05951, U.S. Pat. No. 6,485,736, and U.S. Pat. No. 5,846,554). Microcapsules for use in the present invention may vary from 0.2 to 1000 μm, suitably from 0.5 to 100 μm, and more suitably from 1 to 40 μm.

The encapsulation of a sunscreen by the cosmetics industry has been described as a means of (a) avoiding direct contact between human skin and potentially irritant chemicals while maintaining the efficacy of the sunscreen; and (b) simplifying the formulation of such chemicals. Therefore the reason for encapsulating sunscreens is different from that of the present invention which protects the contents of microcapsules from photo-degradation.

In one known approach, photoprotectants form part or all of the microcapsule wall materials and thus provide a shield for the capsule, thereby protecting any photosensitive AI that is present within the capsules. For example in CA 2133779 Lebo and Detroit show that lignosulphonates and the like can used in combination with a protein such as a high bloom gelatin to form a capsule wall that improves the resistance of agriculturally active substances, such as pesticides, to UV light degradation. The capsule wall formed by the interaction of these components is durable and has a UV protectant as an integral part of its structure.

In another approach, photoprotectants may be co-encapsulated with the AI. The photoprotectant may be dissolved in the core contents of a microcapsule as disclosed by Marcus in WO 9523506A1 for chlorpyrifos or endosulfan. This approach is also used in the printing and duplicating industry where leuco-dyes are co-encapsulated with photoprotectants

Alternatively the photoprotectant may be dispersed as particulate suspensions in the core contents of microcapsule as disclosed in WO96/33611, where the capsule contains particulate suspensions selected from titanium dioxide, zinc oxide and mixtures thereof.

Moy describes in EP539142A1 the use of colloidal inorganic particles, particularly those of silica and zirconium dioxide, to make microcapsules by coacervation or by interfacial polymerisation methods. The process involves the formation of so called Pickering emulsions and the thermoset microcapsule wall comprises the inorganic particles. Moy does not disclose the use of light protecting particles bonded chemically to the capsule walls.

Stover [Macromolecules, 38(7) 2903-2910] describes the incorporation of functionalised organic microspheres into polyurea microcapsule walls made by interfacial polymerisation but does not suggest the use of light protecting particles bonded chemically to the capsule walls.

Odera teaches in JP 86-242834 861013 that titanium dioxide may be incorporated into the walls of 200-500 μm microcapsules made by coacervating gelatine and gum Arabic on a carotene-rape oil mixture in the presence of a titanium dioxide dispersion in the aqueous phase.

The present invention relies on light protecting particles to provide a photoprotectant system for microcapsule formulations. A light-sensitive compound may be contained within the core of a microcapsule and the light protecting particles are chemically bonded to the microcapsule wall, thereby providing photoprotection to the microcapsule wall, to the contents of the core of the microcapsule or to both the wall and the core contents. Although the present invention is most useful when dealing with biologically light-sensitive compounds, it is also appropriate for biologically light-stable compounds which may require a light-sensitive partner [for example, a light-sensitive adjuvant].

The microcapsules of the present invention may be prepared by interfacial polymerisation.

The light protecting particles may provide photoprotection by a variety of means including light absorbance and light reflectance.

The light protecting particles may be organic or inorganic or may comprise a mixture of inorganic and organic compounds [for example Si particles may be impregnated with an organic photo-protectant as described in JP 02002867A2 900108 Heisei].

Furthermore, the light protecting particles may be surface modified by reactive compounds. The light protecting particles may be used in place of conventional surfactants to make stable oil-in-water (so called Pickering) emulsions, in which case wall formation at the oil-water interface is then carried out using compounds dissolved in the oil phase so that the surface modified inorganic particles form chemical bonds with the wall material.

The biologically active compound is suitably a pharmaceutical compound or an agrochemical; more suitably it is an agrochemical.

Suitably, the agrochemical is a fungicide, insecticide or herbicide, used for controlling or combating pests such as fungi, insects and weeds. The agrochemical may also be used in non-agricultural situations [for example public health and professional product purposes, such as termite barriers, mosquito nets and wall-boards].

More suitably the agrochemical is an insecticide, even more suitably a pyrethroid and most suitably lambda-cyhalothrin.

The microcapsules of the present invention may be further processed [for example, in the preparation of granular formulations].

Therefore, in a first aspect, the present invention provides a microcapsule comprising a biologically active compound inside the microcapsule and light protecting particles which are chemically bonded to the microcapsule wall.

The chemical bonds anchor the light protecting particles to the microcapsule wall irreversibly. Further anchorage may be provided when chemical bonds are formed between adjacent light protecting particles.

Suitably the photoprotectant (light protecting particles) is selected from the group consisting of all-trans-(all-E)-1,1′-(3,7,12,16-tetramethyl-1,3,5,7,9,11,13,15,17-octadecanonaene-1,18-diyl)bis[2,6,6-trimethylcyclohexene; 2-ethylhexyl-p-methoxycinnamate; 1,3-bis-[2′-cyano-3′,3-diphenylacryloyl)oxy]-2,2-bis-{[2-cyano-3′,3′-diphenylacryloyl)oxy]methyl}propane; ethyl 2-cyano-3,3-diphenyl-2-propenoate; 2-ethylhexyl-2-cyano-3,3-diphenylacrylate; 2,3-dihydro-1,3,3-trimethyl-2-[(2-methyl-3H-indol-3-ylidene)ethylidene]-1H-Indole, monohydrochloride; 3,6-diamino-10-methylacridinium chloride+3,6-diaminoacridine; monosodium 1-amino-9,10-dihydro-9,10-dioxo-4-(phenylamino)-2-anthracenesulfonate; 1-amino-2-methyl-9,10-anthracenedione; 1,4-bis[(1-methylethyl)amino]-9,10-anthracenedione; 1,4-bis[(4-methylphenyl)amino]-9,10-anthracenedione; 1-hydroxy-4-[(4-methylphenyl)amino]-9,10-anthracenedione; monosodium 4-hydroxy-3-[(2-hydroxy-1-naphthalenyl)azo]-benzenesulfonate; monosodium 4-[(2-hydroxy-1-naphthalenyl)azo]-3-methyl-benzenesulfonate; 4-[(4-nitrophenyl)azo]-N-phenyl-benzenamine; 4-[[4-(phenylazo)-1-naphthalenyl]azo]-phenol; 3-[ethyl[4-[(4-nitrophenyl)azo]phenyl]amino]-propanenitrile; 4-[(4-nitrophenyl)azo]-benzenamine; monosodium 3-hydroxy-4-[(1-hydroxy-2-naphthalenyl)azo]-7-nitro-1-naphthalenesulfonate; 1-[[2,5-dimethyl-4-[(2-methylphenol)azo]phenyl]azo]-2-naphthalenol; 1-[[4-[(dimethylphenyl)azo]dimethylphenyl]azo]-2-naphthalenol; 1-(ortho-tolylazo)-2-naphthol; tetrasodium 4-amino-5-hydroxy-3,6-bis[[4-[[2-(sulfooxy)ethyl]sulfonyl]phenyl]azo]-2,7-naphthalenedisulfonate; 1-[[4-(phenyl)azo)phenyl]azo]-2-naphthalenol; 1-[[3-methyl-4-[(3-methylphenol)azo]phenyl]azo]-2-naphthalenol; 2,3-dihydro-2,2-dimethyl-6-[[4-(phenylazo)-1-naphthalenyl]azo]-1H-perimidine; 1-(phenylazo)-2-naphthalenol; 1-[[2-methyl-4-[(2-methylphenol)azo]phenyl]azo]-2-naphthalenol; 1,3(2H)-dione, 2-(3-hydroxy-2-quinolinyl)-1H-indene; 2-(1,3-dihydro-3-oxo-2H-indol-2-ylidene)-1,2-dihydro-3H-indole-3-one; disodium 2-(1,3-dihydro-3-oxo-5-sulfo-2H-indol-2-ylidene)-2,3-dihydro-3-oxo-1H-indole-5-sulfonate; mixture of 1-(phenylazo)-2-naphthalenol with 1,4-bis[(1-methylethyl)amino]-9,10-anthracenedione; mixture of 1-(phenylazo)-2-naphthalenol with 1,4-bis[(1-methylethyl)amino]-9,10-anthracenedione and 1-[[2-methyl-4-[(2-methylphenol)azo]phenyl]azo]-2-naphthalenol; benzo[a]phenoxazin-7-ium, 5-amino-9-(diethylamino)-, sulfate; N-[4-[[-(diethylamino)phenyl](2,4-disulfophenyl)methylene]-2,5-cyclohexadien-1-ylidene]-N-ethyl-ethanaminium, inner salt, sodium salt; N-[4-[[4-(dimethylamino)phenyl][4-(phenylamino)-1-napthalenyl]methylene]-2,5-cyclohexadien-1-ylidene]-N-methyl-methanaminium chloride; N-[4-[[4-(dimethylamino)phenyl][4-(ethylamino)-1-napthalenyl]methylene]-2,5-cyclohexadien-1-ylidene]-N-methyl-methanaminium chloride; 4,5,6,7-tetrachloro-3′,6′-dihydroxy-2′,4′,5′,7′-tetraiodospiro[isobenzofuran-1(3H),9′-[9H]xanthen]-3-one disodium salt; 2-(3,4-dihydroxyphenyl)-3,5,7-trihydroxy-4H-1-benzopyran-4-one; N,N′,N″,N′″-tetrakis(4,6-bis(butyl-(N-methyl)-2,2,6,6-tetramethylpiperidin-4-yl)amino)triazin-2-yl)-4,7-diazadecane-1,10-diamine; poly[[6-[(1,1,3,3-tetramethylbutyl)amino]-1,3,5-triazine-2-4-diyl][2,2,6,6-tetramethyl-4-piperidinyl)imino]-1,6-hexanediyl[(2,2,6,6-etramethyl-4-piperidinyl)imino]]); mixture of esters of 2,2,6,6-tetra-methyl-4-piperidinol with higher fatty acids (mainly stearic and palmitic acids); propanedioic acid, [(4-methoxy-phenyl)-methylene]-, bis(1,2,2,6,6-pentamethyl-4-piperidinyl)ester; bis(2,2,6,6-tetramethyl-4-piperidyl) sebaceate; bis(1,2,2,6,6-pentamethyl-4-piperidinyl)ester; polymer of N,N′-bis(2,2,6,6-tetramethyl-4-piperidinyl)-1,6-hexanediamine with 2,4,6-trichloro-1,3,5-triazine reaction products with 3-bromo-1-propene, N-butyl-1-butanamine and N-butyl-2,2,6,6-tetramethyl-4-piperidinamine, oxidised, hydrogenated; 4-methyl-2,6-di-tert-butylphenol; octadecyl-3,5-di-tert-butyl-4-hydroxyhydrocinnamate; 2-tert-butyl-1,4-benzenediol; ′2,2′-dihydroxy-4-methoxybenzophenone; 2-hydroxy-4-methoxybenzophenone; 2-hydroxy-4-n-octyloxybenzophenone; 2-(4-diethylamino-2-hydroxybenzoyl)-benzoic acid, hexyl ester; 2,2′,4,4′-tetrahydroxybenzophenone; ′2(2′-hydroxy-5′-t-octylphenyl) benzotriazole; α-[3-[3-(2H-benzotriazol-2-yl)-5-(1,1-dimethylethyl)-4-hydroxyphenyl]-1-oxopropyl]-ω-hydroxy-poly(oxy-1,2-ethanediyl); 2-(2′-hydroxy-3′-dodecanyl-5′-methylphenyl)-benzotriazole; 2-(2H-benzotriazol-2-yl)-4,6-bis(1-methyl-1phenylethyl)phenol; ′2-(2′-hydroxy-3′-t-butyl-5′-methylphenyl)-5-chlorobenzotriazole; ′2-(2′-hydroxy-3,5-di-t-butylphenyl)-5-chlorobenzotriazole; 2-(2H-benzotriazol-2-yl)-4,6-di-tert-pentylphenol; 3-(2H-benzotriazol-2-yl)-5-(1,1-di-methylethyl)4-hydroxy-benzenepropanoic acid, C7-9 branched and linear alkyl esters; 2-[4,6-bis(2,4-dimethylphenyl)-1,3,5-triazin-2-yl]-5-[2-hydroxy-3-(dodecyloxy- and tridecyloxy)propoxy]phenols; zinc oxide; titanium dioxide; mixture of zinc oxide and titanium dioxide; micronised carbon black; 3,5,6-trihydroxybenzoic acid n-propyl ester; sodium iodide; 2,2′-thiobis[4-t-octylphenolato]-beta-butylamine nickel (II); 2-ethyl,2′-ethoxyoxalanilide; 3,9-bis(octadecyloxy)-2,4,8,10-tetraoxa-3,9-diphosphaspiro[5.5]undecane+1,1′,1″-nitrilotris-2-propanol; 3,9-bis[2,4-bis(1-methyl,1-phenylethyl)phenoxy]-2,4,8,10-tetraoxa, 3,9-diphosphaspiro[5.5]undecane; tris(2,4-di-tert-butylphenyl) phosphite; 1,2-dihydroxyanthraquinone; 7-β-D-glucopyranosyl-9,10-dihydro-3,5,6,8-tetrahydroxy-1-methyl-9,10-dioxo-2-anthracenecarboxylic acid; 5-hydroxy-1,4-naphthoquinone; sodium sulfite; distearyl-disulfide; and distearylthiodipropionate.

More suitably, the light protecting particles are selected from zinc oxide; titanium dioxide; and a mixture of zinc oxide and titanium dioxide. Even more suitably the light protecting particles are titanium dioxide particles.

The light protecting particles may be present on the microcapsule wall as a single layer or may be present in a multi-layered system.

In addition to being bonded to the outside surface of the microcapsule wall, the light protecting particles may also be chemically bonded to the inside surface of the microcapsule wall; bonding to the inside surface may be achieved by a preparation process in which the light protecting particles are dispersed in the oil phase prior to emulsification.

In a further aspect, the present invention provides a process for preparing a microcapsule as described above comprising the steps:
(a) forming an oil-in-water emulsion which is colloidally stabilised by light protecting particles by (i) dispersing the light protecting particles in water and (ii) emulsifying in to the water a mixture comprising wall forming materials and the biologically active compound;
(b) reacting the wall forming materials at the oil-water interface with water or with the light protecting particles or with both water and the light protecting particles to form a microcapsule wall; and
(c) causing the light protecting particles to bond chemically to the microcapsule wall.

Throughout this specification, the following abbreviations are used:
THF=TetraHydroFuran; EMA=Ethyl methacrylate; TMSPMA=3-(trimethoxysilylpropyl) methacrylate; DEAEMA=2-(diethylamino)ethyl methacrylate.

In another aspect, the present invention provides a process for modifying the surface of a light protecting particle by a reactive compound where:
(a) said surface has a hydroxyl group;
(b) the reactive compound is a block copolymer in which the first block is a statistical copolymer of 3-trimethoxysilylpropyl methacrylate [TMSPMA] and ethyl methacrylate [EMA] and the second block is a statistical copolymer of 3-trimethoxysilylpropyl methacrylate [TMSPMA] and 2-(diethylamino)ethyl methacrylate [DEAEMA]; and
(c) the light protecting particle and the reactive compound are brought together in a manner such that a 3-trimethoxysilylpropyl methacrylate [TMSPMA] group in the reactive compound reacts with a hydroxyl group on the surface of the light protecting particle to give an irreversibly bound polymer modified surface.

The present invention also provides a surface-modified light protecting particle [suitably titanium dioxide] obtainable by such a process.

For example, a reactive copolymer, such as poly([EMA-s-TMSPMA]-b-[DEAEMA-s-TMSPMA]), is first reacted with light protecting particles, such as titanium dioxide particles, which are subsequently used in place of conventional emulsifiers or colloid stabilisers to disperse an oil droplet which is subsequently incorporated into a capsule wall [that is, the capsule is made via a Pickering emulsion]. By irreversibly binding the particles through chemical bonds, they are not-displaced by subsequent addition of normal surfactants [that is, the particles are colloidally robust].

The reactive compound is designed to enable adjacent surface modified particles to be locked in space by chemically linking the reactive compounds between particles or with microcapsule wall forming materials. This process may be put in to effect by other chemistry.

Those TMSPMA groups that do not react are available for further elaboration as described below. The composition of the reactive compound may be designed such that the surface modified particles are able to form a Pickering emulsion with oil.

The invention is illustrated, but not limited, by the following Examples, in which ‘parts’ are given by weight.

### EXAMPLE 1

This example illustrates the preparation of a reactive block polymer by atom transfer radical polymerisation

Batch 1.

| | | |
|---|---|---|
| EMA¹ | 40 | parts |
| TMSPMA¹ | 4 | parts |
| p-Toluenesulphonyl chloride¹ | 1 | part |
| Toluene¹ | 150 | parts |
| CuCl¹ | 1 | part |

Batch 2.

| | | |
|---|---|---|
| N-propyl 2-pyridylmethanimine² | 2 | parts |

Batch 3.

| | | |
|---|---|---|
| DEAEMA¹ | 7 | parts |
| TMSPMA¹ | 2 | parts |

¹Purchased from Sigma-Aldrich.
²Prepared according to the literature (Haddleton et al., Macromolecules, 1997, 30, 2190)

Batch 1 was charged to a carefully dried, nitrogen filled vessel equipped with gas inlet, septum and magnetic stirrer bar and heated to 90° C. Batch 2 was added via carefully dried, nitrogen flushed syringe and the polymerisation allowed to proceed to ca.90% solids conversion. Batch 3 was then added and the second block polymerised in-situ. The polymerisation solution was diluted by half with dry toluene and, under nitrogen pressure, passed through a short column of carefully dried alumina to remove the copper complex and directly precipitated in dry ice-cold hexane in a sealed vessel.

### EXAMPLE 2

This example illustrates the preparation of a non-reactive polymeric surfactant as a comparison against the reactive polymeric surfactant described in example 1.
Following the procedure described in example 1 [but omitting the TMSPMA monomer] a block copolymer was made where the approximate composition from NMR analysis was [EMA45]-b-[EMA23-s-DEAEMA41].

### EXAMPLE 3

This example illustrates the surface modification of TiO₂ using a reactive polymer. Water (100 parts) was added dropwise to a well dispersed mixture of TiO2 (1 part) and the polymer from example 1 (0.1 parts) in THF (50 parts). The pH of the slurry was adjusted to ca.9 by the addition of triethylamine and THF was removed by rotary evaporation. The surface modified TiO2 particles were separated by centrifugation, washed sequentially with water and acetone, and dried.

### EXAMPLE 4

This example illustrates that reactive surfactants are not desorbed from the TiO₂ particles. Desorption from TiO₂ particles of a reactive surfactant was compared with that of a non-reactive surfactant. The reactive surfactant had an approximate composition by NMR analysis of [EMA46-s-TMSPMA5]-b-[ EMA16-s-DEAEMA40-s-TMSPMA9] while the non-reactive surfactant had an approximate composition of [EMA45]-b-[EMA23-s-DEAEMA41]. A dispersion was made comprising TiO2 (10 parts) and the test surfactant (1 part) in THF. Water was added and the mixture was placed in an ultrasound bath for 15 minutes. The particles were isolated and repeatedly washed with acetone. The washings were analysed by NMR to estimate the amount of desorbed polymer. Approximately 6% and 80% of, respectively, the reactive and non-reactive polymer was desorbed.

### EXAMPLE 5

This example illustrates the formation of microcapsules containing TiO₂ particles embedded in the capsule wall.

A mixture of hexadecane (100 parts), poly(trimethylpropylsilylmethacrylate) (10 parts) and poly(dimethoxysiloxane) (10 parts) was emulsified into water (900 parts) containing surface modified TiO₂ particles (23 parts). Capsule wall formation plus embedding of the particles was catalysed by the addition of triethylamine.

### EXAMPLE 6

This example illustrates the formation of TiO₂ particles embedded in the wall of a capsule containing lambda-cyhalothrin.
An oil phase comprising poly(dimethoxysiloxane) (12.5 parts), Solvesso 200 (2.5 parts) and lambda-cyhalothrin (2.5 parts) was emulsified under high shear into a mixture of sodium chloride (0.57 parts) and TiO2 (2 parts) in water (100 parts). Triethylamine catalyst was added and the suspension was stirred overnight to form a capsule wall.

### EXAMPLE 7

This is a comparative composition of example 6 where the emulsion and then the capsule is formed using a surfactant instead of TiO₂ stabilising particles.
An oil phase comprising poly(dimethoxysiloxane) (12.5 parts), Solvesso 200 (2.5 parts) and lambda-cyhalothrin (5.0 parts) was emulsified under high shear into a solution of sodium dodecyl sulphate (1 parts) in water (100 parts). Triethylamine catalyst was added and the suspension was stirred overnight to form a capsule wall.

### EXAMPLE 8

This is an example of a laboratory Suntest to compare the photostability of lambda-cyhalothrin in the capsules of examples 6 and 7.
The test formulation was dispensed onto pre-scored glass microscope slides and allowed to dry to form deposits, prior to being covered with clean UV transparent silica slides which were irradiated in an Atlas XLS+Suntest™ artificial sunlight simulator that employs a filtered xenon light source providing a spectral energy distribution similar to natural outdoor exposure. The deposits were recovered by extraction with acetone. The percentage of lambda-cyhalothrin that remained was analysed by GC-MS against a series of standards of known concentration. The tabulated results show that the capsule with TiO₂ embedded in the wall gives significant photoprotection.

| | % AI remaining | % AI remaining | T_{1/2} |
|---|---|---|---|
| Example | after 2.25 hours | after 16.25 hours | (hours) |
| Example 6 | 91 | 14 | 6.5 |
| Example 7 | 59 | 6 | 3.9 |

1. A microcapsule comprising a biologically active compound inside the microcapsule and light protecting particles which are chemically bonded to the microcapsule wall.

2. A microcapsule as claimed in claim 1 where there are also chemical bonds between adjacent light protecting particles.

3. A microcapsule as claimed in claim 1 where the biologically active compound is light sensitive.

4. A microcapsule as claimed in claim 1 where the biologically active compound is an agrochemical compound.

5. A microcapsule as claimed in claim 4 where the agrochemical compound is a pyrethroid.

6. A microcapsule as claimed in claim 5 where the pyrethroid is lambda-cyhalothrin.

7. A microcapsule as claimed in claim 1 in which the light protecting particles have been surface-modified by a reactive compound.

8. Use of a microcapsule as claimed in claim 1 to photoprotect a light sensitive biologically active compound.

9. Use of a microcapsule as claimed in claim 1 to combat or control pests.

10. A process for preparing a microcapsule as claimed in claim 1 comprising the steps:
(a) forming an oil-in-water emulsion which is colloidally stabilised by light protecting particles by (i) dispersing the light protecting particles in water and (ii) emulsifying in to the water a mixture comprising wall forming materials and the biologically active compound;
(b) reacting the wall forming materials at the oil-water interface with water or with the light protecting particles or with both water and the light protecting particles to form a microcapsule wall; and
(c) causing the light protecting particles to bond chemically to the microcapsule wall.

11. A process for modifying the surface of a light protecting particle by a reactive compound where:
(a) said surface has a hydroxyl group;
(b) the reactive compound is a block copolymer in which the first block is a statistical copolymer of 3-trimethoxysilylpropyl methacrylate [TMSPMA] and ethyl methacrylate [EMA] and the second block is a statistical copolymer of 3-trimethoxysilylpropyl methacrylate [TMSPMA] and 2-(diethylamino)ethyl methacrylate [DEAEMA]; and
(c) the light protecting particle and the reactive compound are brought together in a manner such that a 3-trimethoxysilylpropyl methacrylate [TMSPMA] group in the reactive compound reacts with a hydroxyl group on the surface of the light protecting particle to give an irreversibly bound polymer modified surface.

12. A process as claimed in claim 11 where the light protecting particle is titanium dioxide.

13. (canceled)
